(19) United States
(12) Patent Application Publication
(10) Pub. No.: US 2022/0103539 A1
(43) Pub. Date: Mar. 31, 2022

(54) VERIFYING TRUSTED COMMUNICATIONS USING ESTABLISHED COMMUNICATION CHANNELS

(71) Applicant: NVIDIA Corporation, Santa Clara, CA (US)

(72) Inventors: Amy Rose, Chapel Hill, NC (US); Christopher Schneider, Hillend (GB); Andrew Woodard, Buckinghamshire (GB); Benjemin Thomas Waine, Cheshunt (GB)

(21) Appl. No.: 17/036,756

(22) Filed: Sep. 29, 2020

(51) Int. Cl. H04L 29/06; H04W 12/06; H04M 7/00

(52) U.S. Cl. CPC H04L 63/083; H04M 7/0078; H04W 12/06

(57) ABSTRACT

In various examples, communications from a host device—which may be associated with an entity—and to a client device may be are verified through established channels of communication. Systems and methods are disclosed that use authentication signals and notifications, which may include predetermined passwords and time-sensitive values, to facilitate verification of the communication between the host device and client device. The notifications may be delivered using applications or web-based applications that are associated with an entity. Once the communication has been verified as trusted, the host device and/or the client device may present notifications that the communication is verified as trusted. The notifications may be presented using audio, video, and/or haptic methods.

### BACKGROUND

As the use of personal mobile devices in exchanging sensitive information continues to proliferate, the volume of spam communications sent to illegitimately obtain such sensitive information has similarly increased. In order for spammers to obtain sensitive information from unsuspecting users, they often contact users on their mobile devices through common channels of communication (e.g., phone call, text message, etc.) purporting to be an entity that would have access to a user's sensitive or confidential information. In some cases, the spammer may be able to spoof the identity of the trusted entity by causing the phone number and caller ID of an incoming call to appear to be from a trusted entity. For example, a spammer may contact a user via a phone call that has a caller ID of “IRS” purporting to be a recognizable government entity (e.g., the Internal Revenue Service) and request that the user divulge sensitive information—such as a Social Security Number.

In response to the increased volume of spammers, users of mobile devices have become wary of responding to communications. For example, instead of assuming that a call purportedly from trusted entity is valid, a user may simply resort to hanging up a phone call shortly after picking up or ignoring the incoming communication altogether. However, this can cause issues when a legitimate entity is attempting to contact a user, since the legitimate entity may be unable to reach a user due to the user's hesitance in responding to unknown communication, causing legitimate, potentially time-sensitive, communications to be ignored.

Conventional systems place the onus on the user to verify the entity initiating communication. For example, a user may receive a phone call from an unknown phone number and may ignore the call without answering it. If the caller leaves a voicemail, the user may listen to the voicemail, determine clues as to the identity of the caller, and begin investigating whether the purported identity of the caller is true. This process, however, is time-consuming, error-prone, and difficult without an established channel of communication between the user and the entity attempting to reach the user. This is because the user must spend time and effort to mine clues from the incoming communication and determine whether the communication is trustworthy using unverified sources on the Internet. In the case of a legitimate communication, the time the user spends to verify the communication may delay the user's response time for resolving a time-sensitive matter. For example, if a bank sends a text message to a user stating that the user had several uncharacteristic credit card charges, the user may spend several minutes verifying the phone number that the communication came from before responding. During the time that the user is verifying the identity of the text message sender (e.g., the bank), the credit card thief may have successfully made additional fraudulent changes. As such, without an established channel of communication and a protocol between a user and a trusted entity, users are left with few options to verify that a communication is valid.

Some conventional systems provide authentication or verification of end-users to entities—such a two-factor authentication, a security token, an authentication application, and/or the like—but these verification techniques are not well suited for an end-user attempting to verify a communication from an entity. For example, in traditional systems, the end-user has no means of verifying that an incoming communication is trusted, even if the host-user was required to perform a verification process prior to initiating the communication. As such, the end-user simply receives the communication—e.g., textual, via phone, etc.—with some identifying information (a phone number, a username, etc.). However, as described above, scammers or other deceptive parties may mimic this identifying information using a variety of different methods in an effort to make a communication appear as valid to an end-user. As a result, the end-user is not able to distinguish between a trusted communication—e.g., a communication that is actually from the identified identity and/or that was initiated using a backend (non-transparent) verification process—and a deceitful communication.

### SUMMARY

Embodiments of the present disclosure relate to verifying trusted communications using established communication channels. The present disclosure relates to a system for verifying that an incoming or received communication is a trusted communication. More specifically, the current disclosure relates to establishing an additional level of authentication between an end-user receiving a trusted communication and a host-user initiating the communication. For example, an end-user with a pre-existing relationship with an entity may receive a communication from a host-user—e.g., a user associated with the entity—claiming to represent the entity, and the user receiving the communication may receive a notification that the communication is trusted through established or otherwise pre-designated protocols and channels.

In contrast to conventional approaches, such as those described herein, the systems and methods of the present disclosure provide for authentication techniques that may verify, to an end-user, a communication from a host-user associated with an entity as a trusted communication. As a result, verification of whether an incoming or received communication is trusted may occur substantially at the same time as the communication is received, without requiring the end-user to separately verify with the entity that the communication was in fact valid or trusted. For example, when a communication is initiated by an entity, the system may generate and transmit an authentication signal to a device of the end-user—e.g., through an established channel of communication, such as an application or webpage associated with the entity and installed on or accessible by the device—to verify that the incoming or received communication is valid or trusted. As such, when the end-user receives the communication, an additional level of verification may be provided via a notification (e.g., a push notification, a message, etc.) that indicates that the incoming or received communication is valid—thereby providing peace of mind to the end-user while minimizing the time and effort required of the end-user to personally verify the communication. In some embodiments, the notification or message may include verification details—such as a verification code or password—and the end-user may require the host-user to verify the code or password prior to continuing on with the communication.

To accomplish this, the system may receive a request to initiate a communication (e.g., a phone call, a voice over internet protocol (VoIP) call, a text message, an instant message, a chat message, or a short message service (SMS) message) between a host device (e.g., a device associated with an entity that the end-user has a relationship with) and a client device of an end-user receiving the communication. In some examples, the system may first require authentication of the host-user prior to initiating the communication. For non-limiting examples, the host-user may be required to enter credentials (e.g., username and password) and/or execute an authentication process (e.g., two-factor authentication, enter a token code, etc.) prior to initiating the communication.

Once a communication is initiated, the system may generate an authentication signal representative of data that may be used to indicate that the communication is trusted. In some non-limiting examples, the system generates a host-side code within a host application on a host device which corresponds to a client-side code on the client device, and the host-side code may be included in the authentication signal. The host-side code and the client-side code may be used to verify the trusted communication. The host-side and client-side codes may be time-sensitive values (e.g., randomly generated numbers) or predetermined passwords (e.g., Personal Identification Numbers (PIN), or secret words) set by the host and client prior to the incoming communication.

The received authentication signal may cause a client application (e.g., a mobile application, a webpage, etc.) that is associated with an entity to generate an indication of the trusted nature of the communication (e.g., notification within an application or webpage, a push notification on a display of the client device, a notification indicator corresponding to the application, etc.). For example, the web server hosting the webpage or the client application may verify the data from the authentication signal—e.g., against a time-sensitive value, a password, a code, etc.—prior to generating and/or displaying the indication of the trusted nature or validity of the communication. In some examples, an additional client-side code or password—that corresponds to a host-side code or password displayed to the host-user—may be displayed along with the indication of the trusted communication. As such, once the trusted communication is initiated, the host-user may provide the host-side code to the end-user in order to provide further verification to the end-user that the communication is trusted.

### BRIEF DESCRIPTION OF THE DRAWINGS

The present systems and methods for verifying trusted communications using established channels of communication are described in detail below with reference to the attached drawing figures, wherein:

FIG. 1 is an example system diagram of a communication verification system, in accordance with some embodiments of the present disclosure;

FIG. 2A is an example screenshot from a graphical user interface (GUI) for receiving an incoming call, in accordance with some embodiments of the present disclosure;

FIG. 2B is another example screenshot from a GUI for receiving a notification to verify an incoming call, in accordance with some embodiments of the present disclosure;

FIG. 3A is an example screenshot from a GUI of a webpage of a trusted entity, in accordance with some embodiments of the present disclosure;

FIG. 3B is another example screenshot from a GUI for receiving a notification to verify an incoming call on a webpage of an entity, in accordance with some embodiments of the present disclosure;

FIG. 4A is an example screenshot from a GUI for an outgoing call that has been placed from an application, in accordance with some embodiments of the present disclosure;

FIG. 4B is another example screenshot from a GUI for receiving a notification to verify an outgoing call, in accordance with some embodiments of the present disclosure;

FIG. 5A is an example screenshot from a GUI of a webpage of a trusted entity, in accordance with some embodiments of the present disclosure;

FIG. 5B is another example screenshot from a GUI of a webpage of a trusted entity for receiving a notification to verify an outgoing call, in accordance with some embodiments of the present disclosure;

FIG. 6 is a flow diagram showing a method for generating and transmitting an authentication signal with an indication of a trusted communication, in accordance with some embodiments of the present disclosure;

FIG. 7 is a flow diagram showing a method for verifying a communication and notifying a recipient of the communication, in accordance with some embodiments of the present disclosure;

FIG. 8 is a flow diagram showing a method for verifying a communication and notifying a recipient of the communication using a webpage associated with the entity, in accordance with some embodiments of the present disclosure;

FIG. 9 is a block diagram of an example computing environment suitable for use in implementing some embodiments of the present disclosure; and

FIG. 10 is a block diagram of an example data center suitable for use in implementing some embodiments of the present disclosure.

### DETAILED DESCRIPTION

Systems and methods are disclosed related to verifying trusted communications using established channels of communication. For example, in contrast to conventional systems, for communications from trusted entities, the host device that initiated the communication may be verified and authenticated through an established protocol between the user and the trusted entity. As a result, the user may be more confident and assured that an incoming communication is from a trusted entity (instead of a spammer) without the need to ignore the communication and separately investigate and authenticate the origins of the incoming communication.

In some embodiments, the user and trusted entity may have a preexisting relationship prior to the communication. For example, the user may have a registered account with the entity and/or may have downloaded an application hosted by the entity onto their mobile device. In one or more examples, the user may access their registered account with the entity through a web-based application on a webpage hosted by the trusted entity.

When an incoming communication from a trusted entity is received, the user may also receive a notification through an established channel of communication (e.g., an application associated with the entity) that the incoming communication is trusted and is from the trusted entity. The notification may be caused by an authentication signal that was generated in response to a request to initiate a communication from a host device to a client device of the user.

Using the established channels of communication, the host device (and the communication initiated from the host device) may be verified in a number of ways. For example, the host device may generate a host-side code and the client device may also generate (or receive) a client-side code. The host-side code may be verified by determining if the host-side code matches the client-side code, without any input from the client or host devices. In one or more examples, the host-side code may be transmitted to the client device for verification. The client device may receive the host-side code through the ongoing communication and either provide confirmation that the codes match or provide the host-side code itself to authentication server(s). Based on the outcome of the comparison of the host-side code against the client-side code, the client devices (and/or host devices, in embodiments) may receive notifications regarding whether the communication is verified as trusted as being from a particular entity.

As a direct result of some embodiments of the systems and methods described herein, the resources and time of the system needed in reaching a user are reduced because fewer repeated communications to reach a user are necessary (e.g., the user is more confident that a communication is from a trusted entity and is more likely to engage in an incoming communication from the trusted entity when verified through an established channel of communication). In addition, because only users who are actively being contacted need to connect to the system over the network, the networking requirements are also reduced, and the integrity of the system is more likely to be maintained as compared to conventional systems (e.g., less lag, less drop offs, etc.). Thus, the user is able to accomplish the same goals—e.g., of verifying the trusted nature of an incoming communication—while reducing the burden on the system and the network(s) supporting the system.

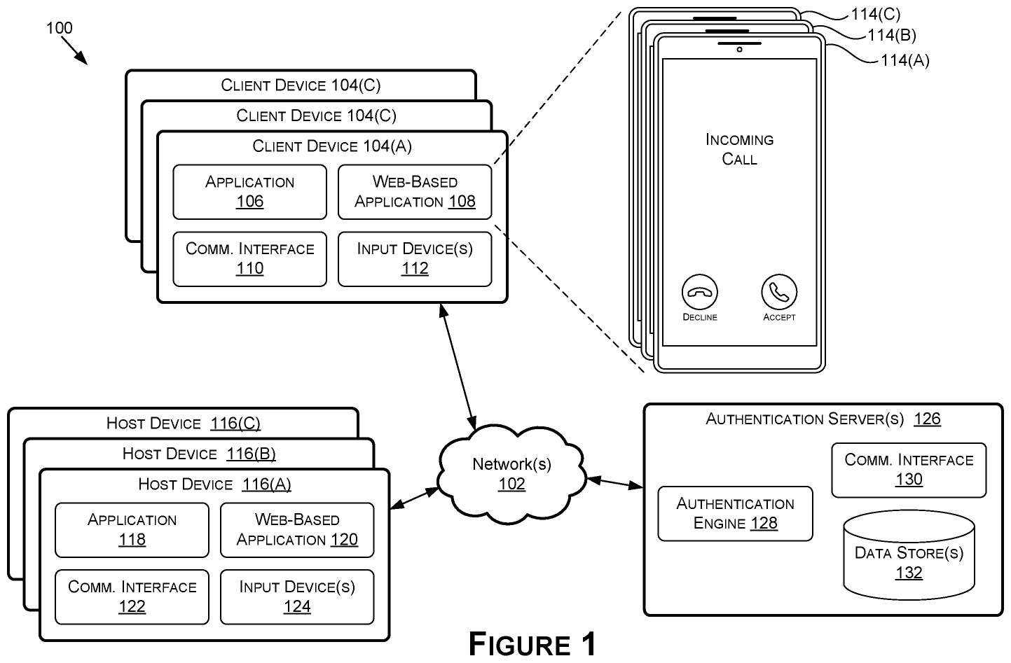

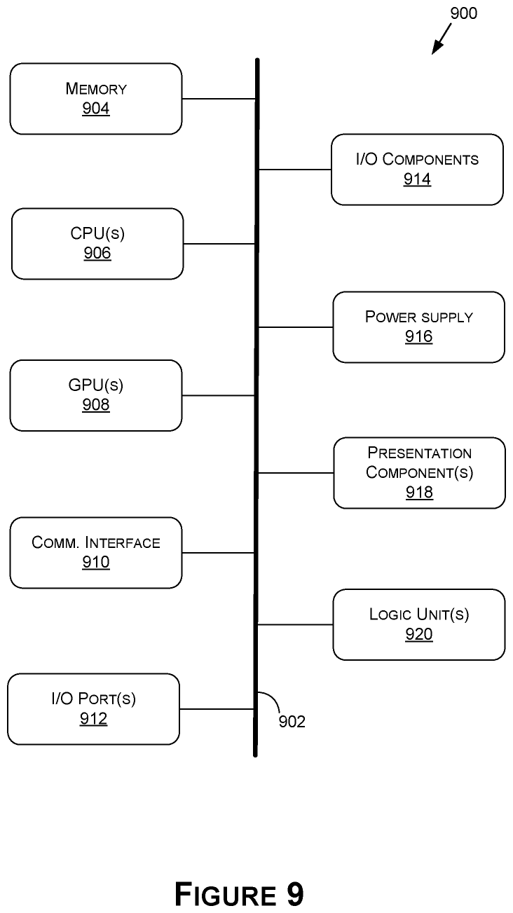

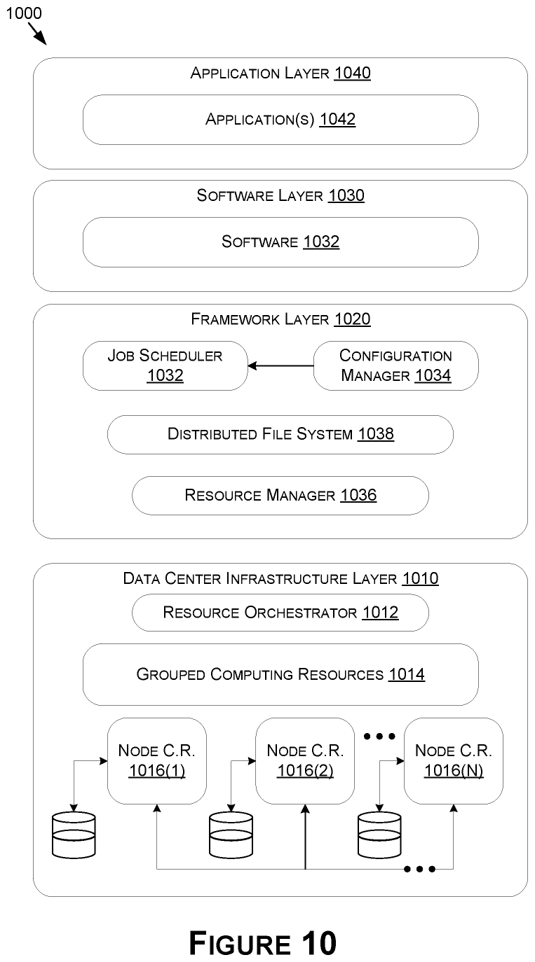

With reference to FIG. 1, FIG. 1 is an example system diagram of a communication verification system 100 (alternatively referred to herein as “system 100”), in accordance with some embodiments of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, host device(s) 116 and/or authentication server(s) 126 may include similar features, functionality, and/or components as those described herein with respect to example data center 1000 of FIG. 10. In addition, client device(s) 104, host device(s) 116, and/or authentication server(s) 126 may include similar features, functionality, and/or components as those described herein with respect to example computing device 900 of FIG. 9.

The communication verification system 100 may include, among other things, any number of client devices 104(A), 104(B), and 104(C) (referred to collectively herein as “client devices 104”), any number of host devices 116(A), 116(B), and 116(C) (referred to collectively herein as “host devices 116”), and/or one or more authentication server 126. Although the client devices 104(A), 104(B), and 104(C) are illustrated in FIG. 1, this is not intended to be limiting. In any example, there may be any number of client devices 104 and/or host devices 116.

Components of the communication verification system 100 may communicate over network(s) 102. The network(s) may include a wide area network (WAN) (e.g., the Internet, a public switched telephone network (PSTN), etc.), a local area network (LAN) (e.g., Wi-Fi, ZigBee, Z-Wave, Bluetooth, Bluetooth Low Energy (BLE), Ethernet, etc.), a low-power wide-area network (LPWAN) (e.g., LoRaWAN, Sigfox, etc.), a global navigation satellite system (GNSS) network (e.g., the Global Positioning System (GPS)), and/or another network type. In any example, each of the components of the communication verification system 100 may communicate with one or more of the other components via one or more of the network(s) 102.

The client devices 104 may include a smart phone, a laptop computer, a tablet computer, a desktop computer, a wearable device, a game console, a virtual reality system (e.g., a headset, a computer, a game console, remote(s), controller(s), and/or other components), an NVIDIA SHIELD, a smart-home device that may include an intelligent personal assistant, and/or another type of device capable of processing user input and providing notifications.

The client devices 104 may include an application 106, a web-based application 108, a communication interface 110, and/or input device(s) 112. Although only a few components and/or features of the client device 104 are illustrated in FIG. 1, this is not intended to be limiting. For example, the client devices 104 may include additional or alternative components, such as those described below with respect to the computing device 900 of FIG. 9.

The application 106 may be a mobile application, a computer application, a console application, and/or another type of application. The application 106 may include instructions that, when executed by a processor(s), cause the processor(s) to, without limitation, receive input data representative of user inputs to the one or more input device(s) 112, transmit the input data to the authentication server(s) 126, generate, receive, and transmit authentication signals from/to authentication server(s) 126, and cause presentation of notifications on client devices 104. In other words, the application 106 may operate as a facilitator for verifying communications initiated from host devices 116.

The application 106 may be associated with and/or hosted by a particular entity. The users of client devices 104 and the entity may have a pre-existing relationship prior to any initiated communications from the entity. For example, the entity may be, without limitation, a financial institution or an educational institution, where the relationship involves the exchange of sensitive information such as financial information or personally identifiable information. Given the potentially sensitive nature of the relationship, the application 106 may have a secure connection to authentication servers 126 and/or other resources associated with the entity.

Acting as the conduit between the client devices 104 and the trusted entity, the application 106 may be linked and have access to a user's registered account with the entity. For example, in order to provide notifications for incoming communications from the trusted entity, the application 106 may be pre-installed on client devices 104 and associated with a registered account associated with the entity. The application 106 may access the user's account and process any incoming associated notifications after the user successfully provides valid credentials associated with the user's account with the entity and/or successfully passes a second layer of authentication such as multi-factor authentication.

The application 106 may be capable of processing authentication signals received by the client device(s) 104. For example, the client device(s) 104 may receive authentication signals from authentication server(s) 126 in response to a communication initiated by host devices 116. The authentication signal may specify the type of notification to present to the user, including the content of the notification and/or the delivery mechanism of the notification (e.g., audible, visual, tactile, etc.). The authentication signal may include a host-side code that may correspond—where valid—to a client-side code generated by the client devices 104.

Using the data represented by the authentication signal, the application 106 may present notifications on the client device(s) 104. The notifications presented by the client device(s) 104 may be in audio, haptic, and/or visual forms. For example, the application 106 may present an audio clip on the client devices 104 that describes the context of an incoming phone call. The application 106 may also present a haptic notification, such as vibration of the client devices 104, in response to an authentication signal. Likewise, the application 106 may present a visual notification such as a text banner that describes an incoming communication as being associated with an entity. Similarly, the application 106 may present a notification indicator, such as a number near the vicinity of the application 106 icon on the client device(s) 104 indicating that there is an unopened notification waiting for the user of the client device(s) 104 to open. Triggered by the received authentication signal, in embodiments, the notification may be presented by the application 106 on the client device(s) 104 before and/or during the time that an incoming communication is received and/or presented.

The presentation of the notification may be also determined by a user's prior settings on the client device(s) 104. For example, if the user has allowed push notifications from application 106, then the notification may be received by application 106 using push technology or other forms of technology that provide real-time notification of the nature of an incoming communication. In some examples, the user may specify that the application 106 use other forms of technology, such as pull technology, to retrieve and present notifications.

The application 106 may present different notifications based on the received authentication signal. For example, if an initial authentication signal indicates that an incoming communication to client devices 104 is associated with an entity, then the application 106 may present a notification that mentions the entity and the incoming communication. An additional received authentication signal, however, may indicate that the ongoing communication has been verified as trusted. In turn, the application 106 may generate an additional notification stating that the ongoing communication is verified as trusted.

To facilitate the verification process of an incoming communication, the application 106 may generate a client-side code. The client-side code may correspond to a host-side code that is generated by the host device(s) 116. The value may be a time-sensitive value, a password, PIN number, secret word, or an identification number. In some examples, the client-side and host-side codes are predetermined prior to the initiation of the communication. These values may be used to verify the user that initiated a communication using the host device(s) 116. In some examples, these codes may be stored as a cookie on the client device(s) 104.

In some embodiments, the application 106 may facilitate additional layers of verification of the user initiating a communication using host devices 116. For example, the user of the client device(s) 104 may request to engage in additional layers of authentication regarding a communication initiated by the entity. Additional authentication signals may be generated and received by the client device(s) 104 based on the additional layers of verification requested by the user of the client device(s) 104. In some examples, the user of the client device(s) 104 may request that the user of the host device(s) 116 provide a host-side code through the ongoing communication channel and the application 106 may request confirmation that the received host-side code matches the client-side code. Additionally, the application 106 may provide a pop-up keypad for the user of the client device(s) 104 to input a host-side code as recited through the ongoing verification. Likewise, the application 106 may verify the host-side code matches the client-side code locally on the client device(s) 104, provide confirmation of host-side and client-side codes matching to the authentication server(s) 126, or send both codes to the authentication server(s) 126 for verification. After receiving information regarding the host-side code, the application 106 may generate an authentication signal to transmit the host-side code or confirmation of matching codes to authentication server(s) 126. In some embodiments, responsive to the verification, the client device(s) 104 may receive another authentication signal that indicates whether the ongoing communication is trusted.

The client-side code and the host-side code may also be verified without input from client devices 104 or host devices 116. In some examples, the host-side code—e.g., that is received via the authentication signal—may be verified against the client-side code. The verification may take place locally on the client device(s) 104 after receiving the host-side code. For example, the client device(s) 104 may receive the host-side code via authentication signal, compare it against the client-side code, and then provide a confirmation of the verification to authentication server(s) 126. In some examples, the client device(s) 104 and host device(s) 116 may send their respective client-side and host-side codes to authentication server(s) 126 for verification without participation of the users involved in the communication.

The web-based application 108 may be an application executed through a web browser, and/or another type of application. The web-based application 108 may include instructions that, when executed by a processor(s), cause the processor(s) to, without limitation, receive input data representative of user inputs to the one or more input device(s) 112, transmit the input data to the authentication server(s) 126, generate, receive, and transmit authentication signals from/to authentication server(s) 126, and cause presentation of notifications on client devices 104. The web-based application 108 may operate as a facilitator for verifying communications initiated from host devices 116 through a web-browser.

The web-based application 108 may be associated with and hosted by a particular entity. As mentioned with respect to application 106, the users of client devices 104 and the entity hosting web-based application 108 may have a pre-existing relationship prior to any initiated communications from users associated with the entity.

The web-based application 108 may be executed through the use of a web browser when the client devices 104 accesses a website or webpage hosted by the entity. The web-based application 108 may be an application that is delivered through a web browser. The web-based application 108, once executed on a web browser, may be tied to a user's registered account with the entity. The web-based application 108 may require the user of the client devices 104 to provide credentials prior to presenting any notifications. For example, the entity hosting the web-based application may be a financial institution or an educational institution and require that a user provide credentials prior to viewing information pertinent to the user's account associated with the entity. The web-based application 108 may allow access to a user's account after successful verification of additional layers of authentication such as multi-factor authentication.

The web-based application 108 may be capable of processing data or information from authentication signals. In response to communications initiated by a host device(s) 116 to a user with an associated account with the entity, the web-based application 108 may receive authentication signals from authentication server(s) 126. The authentication signal may specify the type of notification to present based on the initiated communication. The authentication signal may also include the content of the notification and the delivery mechanism of the notification (e.g., in a message queue, as a popup, etc.).

Based on the authentication signal, the web-based application 108 may present notifications including the context and content derived from the authentication signal. The notification may take various forms, including audio, visual, and/or haptic. In some examples, the notification may be a pop-up window with text that notifies the user that the incoming communication is associated with the entity. Likewise, the web-based application 108 may provide a notification indicator that displays the number of unread notifications attributed to the user's account. In some examples, the notification indicator may be located near the user's account name on the webpage associated with the entity. In some embodiments, upon successful login or authentication, a popup may be displayed within the web-based application 108 indicating that a to-be-received, current, and/or past communication is or was valid. The web-based application 108 may provide several notifications regarding verification of the user initiating the communication, such as a notification that the incoming communication is associated with an entity and a notification that a particular communication is verified as trusted.

The web-based application 108 may also generate client-side codes that may be used to verify the user initiating the communication. The client-side codes may be time-sensitive values, passwords, one-time passwords, PIN, secret words, answers to a security question, and identification numbers. These client-side codes may be transmitted to authentication server(s) 126 to determine whether the host-side code matches. In some examples, the client-side code may be stored in a cookie of the client devices 104.

As described with respect to notifications generated by the application 106, the notification presented by the web-based application 108 may also include a generated client-side generated code that may be used to further verify the user that initiated the communication. For example, the client-side code may be generated by the web-based application 108 and match a similar code being generated by the host device(s) 116. In some examples, the web-based application 108 may prompt a user, through a notification, to request that the user initiating the communication provide a matching host-side code. The web-based application 108 may provide a user interface for the user of the client device(s) 104 to input a host-side code provided by the user initiating the communication. The generated client-side code and received host-side code may be verified by the client device(s) 104 and/or sent to the authentication server(s) 126 for verification.

The communication interface 110 may include one or more components and features for communicating across one or more networks, such as the network(s) 102. The communication interface 110 may be configured to communicate via any number of network(s) 102, described herein. The communication interface 110 may also receive and transmit communications across several channels of communication, including a phone call over a public switched telephone network (PSTN) or cellular network, a voice over internet protocol (VoIP) call, a text message, or a short message service (SMS) message. For example, the communication interface 110 may receive an incoming PSTN phone call, as shown in the client device screenshot 114(A). In some examples, to communicate in the communication verification system 100 of FIG. 1, the client devices 104 may use an Ethernet or Wi-Fi connection through a router to access the Internet in order to communicate with the authentication server(s) 126, host devices 116, and/or with other client devices 104.

The input device(s) 112 may include any type of devices that are capable of providing user inputs to the application 106 or web-based application 108. The input device(s) may include a keyboard, a mouse, a touch-screen display, a controller(s), a remote(s), a headset (e.g., sensors of a virtual reality headset), and/or other types of input devices.

The host devices 116 may include a smart phone, a laptop computer, a tablet computer, a desktop computer, a wearable device, a game console, a virtual reality system (e.g., a headset, a computer, a game console, remote(s), controller(s), and/or other components), an NVIDIA SHIELD, a smart-home device that may include an intelligent personal, and/or another type of device capable of processing user input and providing notifications.

The host devices 116 may include an application 118, a web-based application 120, a communication interface 122, and/or an input device(s) 124. Although only a few components and/or features of the host devices 116 are illustrated in FIG. 1, this is not intended to be limiting. For example, the host devices 116 may include additional or alternative components, such as those described below with respect to the computing device 900 of FIG. 9.

The application 118 may be a mobile application, a computer application, a console application, and/or another type of application. The application 118 may include instructions that, when executed by a processor(s), cause the processor(s) to, without limitation, receive input data representative of user inputs to the one or more input device(s) 124, transmit the input data to the authentication server(s) 126, generate, receive, and transmit authentication signals from/to authentication server(s) 126, and cause presentation of notifications on host devices 116. In other words, the application 118 may operate as a facilitator for verifying communications initiated from host devices 116.

The application 118 may be associated with an entity. The entity, as mentioned above with respect to application 106, may have many other registered users, such as users of client devices 104. For example, a user of the host device(s) 116 may have a registered account with an entity and the user of the client device(s) 104 may also have a registered account with the entity. The application 118 may require successful submittal and verification of credentials prior to authorizing a user to access the resources of application 118. In some examples, the application 118 may prompt the user of host devices 116 to successfully complete an authentication challenge (e.g., two-factor authentication) prior to being authorized to generate a request to initiate communication with another registered user. In some examples, the host devices 116 may be issued by the entity and require no additional authentication challenges.

The application 118 may receive a request to initiate a communication to client devices 104 and trigger a notification to authentication server(s) 126. For example, the application 118 may receive a request to communicate via a phone call over a public switched telephone network (PSTN) or a cellular network, a voice over internet protocol (VoIP) call, a text message, an instant message, or a short message service (SMS) message. In response to a request to initiate a communication, the application 118 may generate an authentication signal to authentication server(s) 126 that describes the type of communication being placed. For example, a request to place a phone call to a registered user associated with the entity may be received and the application 118 may generate and transmit a signal to authentication server(s) 126 to begin the verification process, which in turn may trigger an authentication signal from the authentication server(s) 126 to the client device(s) 104.

The application 118 may generate a host-side code that may be used to authenticate the communication associated with the entity. The host-side code may match—where valid—a client-side code that is generated by client devices 104. The host-side code may be a time-sensitive value, such as a one-time password or randomly generated passwords, or other types of predetermined passwords provided by the user, including a PIN, secret word, answer to a security question, or identification number.

To enable verification of the communication as trusted, the application 118 may provide the host-side code in a variety of ways. For example, the application 118 may cause the host device(s) 116 to transmit the host-side code directly to the client devices 104 via authentication signal or indirectly to client devices 104 via authentication server(s) 126 for verification on the client devices 104 themselves. Likewise, the application 118 may cause the host device(s) 116 to directly send, via authentication signal, the host-side code to authentication server(s) 126 for verification against the client-side code. In some examples, the application 118 may generate a notification for the user of the host device(s) 116 to recite the host-side code in the ongoing communication, as described in greater detail below.

The application 118 may present notifications on the host device(s) 116 regarding additional layers of authentication. For example, the host-side code that is used for additional verification may be presented on the host device(s) 116 via notification. The notification may be presented in audio, visual, haptic, and/or another format. In some examples, the notification may include additional instructions that prompts the user of the host device(s) 116 to provide (e.g., orally, through text input, etc.) the host-side code to the user of the client devices 104.

The application 118 may operate with communication interface 110 to initiate communications as requested by the user. For example, if the user of host devices 116 requests to place a phone call to another user registered with the entity, the application 118 may provide the communication details to communication interface 110 to place the phone call to the designated user using a selected protocol, such as VoIP.

The application 118 may retrieve and present information regarding other users registered with the entity. For example, the application 118 may receive the contact information for registered users of an entity that the user of the host devices 116 is associated with. The application 118 may cause the contact information to be presented and may receive a selection of a registered user to initiate a communication with. The host device(s) 116 may transmit information regarding the selected registered user to the authentication server(s) 126 in the request to initiate a communication.

The application 118 may also receive data indicating that the host device(s) 116 has been successfully authenticated. For example, the host-side code may be provided to the user of the client device(s) 104, who may input the host-side code for verification. If the host-side code matches the client-side code as determined by the authentication server(s) 126, then data indicating that the host device(s) 116 is authenticated and/or the communication is trusted may be received.

Once the host devices 116 are authenticated, the application 118 may provide additional information regarding the communication recipient that is registered with the entity. For example, if the host devices 116 are successfully authenticated, the application 118 may retrieve and provide access to sensitive information regarding the registered user, including personally identifiable information and financial information. In some examples, the authentication of the host device(s) 116 may be specific to each client device 104 that is being communicated with. For instance, the host device(s) 116 may be required to successfully pass authentication challenges for each and every user that is being contacted in order to view additional information about the particular user associated with client device(s) 104.

The web-based application 120 may be an application executed through a web browser, and/or another type of application. The web-based application 120 may include instructions that, when executed by a processor(s), cause the processor(s) to, without limitation, receive input data representative of user inputs to the one or more input device(s) 124, transmit the input data to the authentication server(s) 126, generate, receive, and transmit signals from/to authentication server(s) 126, and cause presentation of notifications on host devices 116. In other words, the web-based application 120 may operate as a facilitator for verifying communications initiated from host devices 116 through a web-browser.

Web-based application 120 may similarly be associated with an entity. The web-based application may be accessed through a website or webpage associated and/or hosted by the entity. In some examples, the web-based application may be an internal application that is only accessible via a local area network or intranet. The web-based application may deny access to information until valid credentials associated with a registered user of the entity that has corresponding access rights are submitted. Web-based application 120 may also initiate additional layers of authentication.

The web-based application 120 may provide an interface for users of host devices 116 to initiate communications with other registered users associated with the entity. Similar to application 118, the web-based application 120 may receive requests to initiate communications, such as a phone call over a public switched telephone network (PSTN) or a cellular network, a voice over internet protocol (VoIP) call, a text message, an instant message, or a short message service (SMS) message, with another registered user associated with an entity. When a request to initiate communication is received, the web-based application 120 may cause an authentication signal to be sent to authentication server(s) 126 with information such as the recipient of the communication and the type of communication being requested. For example, the web-based application 120 may receive a request to initiate a phone call to a particular user and the host device(s) 116 may transmit an authentication signal to the authentication server(s) 126 that includes details regarding the communication being requested. This authentication signal, in turn, may trigger the authentication server(s) 126 to send another authentication signal to client devices 104.

As described with respect to application 118, the web-based application 120 may also generate a host-side code that may be used to authenticate the host devices 116 in connection with an initiated communication. For instance, the web-based application 120 may generate a host-side code, such as a random number, that matches a random number generated by similar means by application 106 on client devices 104. The host-side code may be in a variety of formats, such as a time-sensitive value, including one-time passwords or randomly generated passwords, or other types of predetermined passwords provided by the user, including a PIN, secret word, answer to a security question, or identification number. The host-side code from the host devices 116 and the client-side code from client devices 104 may be transmitted to authentication server(s) 126 for verification on the back-end without involvement of the users of the client device(s) 104 and host devices 116. Likewise, the host-side code may be sent directly to client device(s) 104 via an authentication signal, or forwarded, by authentication server(s) 126, to client devices 104 for verification. In some examples, the host-side code may be transmitted to the client device(s) 104 via the ongoing communication and the host-side code may be input into client devices 104 for verification by authentication server(s) 126.

The web-based application 120 may also present notifications on host devices 116. In some examples, the notifications may provide confirmation of a successful authentication challenge. The notification may also provide a host-side code or issue an authentication challenge that may be used to authenticate host devices 116. For instance, the notification may provide a host-side code along with a set of instructions for how to use the host-side code, such as requesting that the host-side code be provided as a part of the ongoing communication. The notification may be presented in several different forms, such as audio, visual, and/or haptic formats. Each notification may also be presented on the host devices 116 via the webpage as a pop-up notification, notification indicator, notification banner, among other ways. Likewise, the notification may be delivered in several ways, including push technology or other forms of technology that provide notifications in real-time.

The web-based application 120 may also operate with communication interface 122 to facilitate the requested communication to the selected user. For instance, if a phone call to a particular user has been requested, the web-based application 120 may initiate VoIP resources to place the call over the Internet.

The web-based application 120 may also retrieve information regarding other registered users and present the information on host devices 116. For instance, the web-based application may present the contact information—such as a customer's phone number—of registered users that have accounts with the entity. A particular user's contact information may then be selected to begin a communication. The web-based application 120 may cause this information to be included as part of an authentication signal transmitted to the authentication server(s) 126.

The web-based application may also receive data regarding the successful authentication of the host device(s) 116. For example, once the host device(s) 116 has passed an authentication challenge, such as providing a host-side code that matches a client-side code in the ongoing communication, the host device(s) 116 may receive a confirmation that the authentication challenge has been successfully completed and that the communication is verified as trusted.

After successful authentication of the host device(s) 116, the web-based application 120 may provide access to a user's sensitive information in response to receiving data representing successful authentication of the communication. For instance, if the initiated communication is in regards to a delivery of a package, the web-based application may only display a registered user's phone number at first. Once the host devices 116 have been successfully authenticated and the communication is verified as trusted, the host devices 116 may then retrieve and present the particular user's sensitive information such as home address and method of payment information. The layers of authentication for access to sensitive information may vary, such as issuing a more difficult authentication challenge for access to a Social Security number and issuing a less stringent challenge for access to a mailing address. In some examples, where the host devices 116 are issued by the entity and hosted on an intranet, the web-based application 120 may not require additional layers of authentication.

The communication interface 122 may include one or more components and features for communicating across one or more networks, such as the network(s) 102. The communication interface 122 may be configured to communicate via any number of network(s) 102, described herein. The communication interface 122 may also receive and transmit communications across several channels of communication, including a phone call over a public switched telephone network (PSTN) or cellular network, a voice over internet protocol (VoIP) call, a text message, or a short message service (SMS) message. For example, to communicate in the communication verification system 100 of FIG. 1, the client devices 104 may use an Ethernet or Wi-Fi connection through a router to access the Internet in order to communicate with the authentication server(s) 126, client devices 104, and/or with other host devices 116.

The input device(s) 124 may include any type of devices that are capable of providing user inputs to the application 118 or web-based application 120. The input device(s) may include a keyboard, a mouse, a touch-screen display, a controller(s), a remote(s), a headset (e.g., sensors of a virtual reality headset), and/or other types of input devices.

The authentication server(s) 126 may include an authentication engine 128, a communication interface 130, and/or data store(s) 132. Although only a few components and/or features of the authentication server(s) 126 are illustrated in FIG. 1, this is not intended to be limiting. For example, the authentication server(s) 126 may include additional or alternative components, such as those described below with respect to the computing device 900 of FIG. 9 and/or the example data center 1000 of FIG. 10. For example, the authentication server(s) 126 may include one or more servers, application programming interfaces (APIs), back-end devices, and/or other device types for generating, managing, transmitting, receiving, and/or generating authentication of host devices 116.

The authentication engine 128 may facilitate verification of a communication as trusted using authentication signals and/or by causing generation of notifications on client devices 104 and/or host devices 116. For example, based on a request to initiate a communication with a user, the authentication engine 128 may generate an authentication signal for transmission to the client device(s) 104. For instance, once the host device(s) 116 issues a request to initiate the communication, the authentication engine 128 may initiate the communication and simultaneously generate and transmit an authentication signal to the client device(s) 104. The authentication signal may include instructions to present a notification with specific content, such as the name of the entity initiating the call, on the client device(s) 104. The authentication engine 128 may also provide multiple authentication signals corresponding to the number and/or types of notifications to present via the client device(s) 104. For example, the authentication engine 128 may transmit an authentication signal to client devices 104 that instructs the client devices 104 to present a notification stating that incoming communications are associated with a particular entity. Once the authentication of host devices 116 has been successfully completed, the authentication engine 128 may transmit a second authentication signal stating that the ongoing communication from the entity is a trusted communication.

The authentication engine 128 may authenticate the host devices 116 through the ongoing communication initiated by the host devices 116 using host-side and/or client-side codes. For example, based on the authentication signal, the client devices 104 may generate a client-side code. Likewise, in response to the request to initiate a communication, the host devices 116 may generate a matching host-side code. In some examples, the host-side code may be presented on host devices 116 and requested to be recited or transmitted to the user of the client devices 104. The host-side code may then be input into client devices 104, which may be transmitted to the authentication server(s) 126 and ultimately authentication engine 128. The host-side code may also be sent along with the client-side code to authentication engine 128 to verify that the codes match. In some examples, the client devices 104 may receive the host-side code via the ongoing communication and determine whether the codes match and transmit a confirmation to authentication engine 128. The host-side code may also be presented and input by the user of the host devices 116 into a pop-up prompt with a keypad or keyboard to enter the host-side code.

The authentication engine 128 may, in embodiments, authenticate host devices 116 without the participation of the users using client devices 104 and host devices 116 using back-end methods. For instance, after the client devices 104 and host devices 116 have generated their respective client-side and host-side codes, the authentication engine 128 may receive these codes via authentication signals from the respective devices to verify that they match. In some examples, the authentication engine 128 may receive a host-side code and transmit the code to the client devices 104 in order for the client devices 104 to verify that that host-side code matches the generated client-side code.

As such, the authentication engine 128 may manage the presentation of notifications on the client devices 104 and/or the host devices 116 through authentication signals. For example, as described herein, the authentication engine 128 may generate an authentication signal to the client device(s) 104 when a request to initiate a communication is received from the host device(s) 116. The authentication signal may include information—e.g., as derived from the request to initiate a communication—to present in a notification on the client device(s) 104. For instance, the authentication engine 128 may include the type of communication and/or the entity initiating the communication in the authentication signal, and the authentication signal may be configured to instruct the client devices 104 to present the information in a notification. Similarly, the authentication engine 128 may cause the host device(s) 116 to present notifications that include the host-side code and instructions to provide the recipient of the initiated communication with the host-side code.

In some embodiments, the authentication engine 128 may manage access to data store(s) 132 based on the authentication of a user using host devices 116. For instance, if the host device 116 requests access to sensitive information regarding a registered user, the authentication engine 128 may deny access to data store(s) 132 until the host device(s) 116 successfully passes authentication challenges described above. The data store(s) 132 may store the credentials of users registered with the entity initiating the communication along with other information about registered users, such as contact information, notification preferences, and/or a list of devices associated with the registered user's account. In some examples, the authentication engine 128 may authenticate a user's credentials when a user logs into the entity's application 118 or web-based application 120 and determine the access rights associated with the user of the host device(s) 116. Similarly, the authentication engine 128 may validate the credentials of a user using application 106 or web-based application 108 on the client device(s) 104.

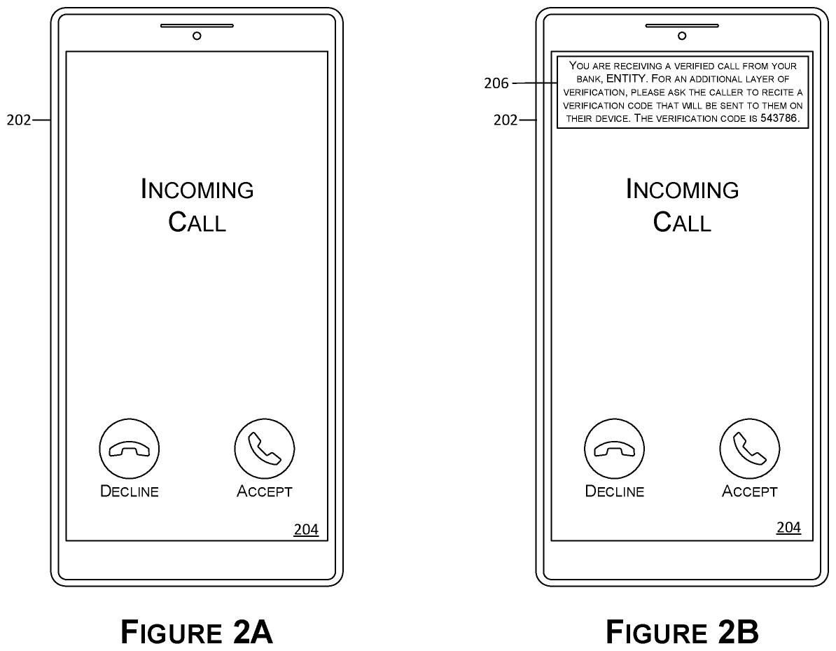

Now referring to FIG. 2A, FIG. 2A is an example screenshot from a graphical user interface (GUI) 204 for receiving a phone call from a user associated with a trusted entity, in accordance with some embodiments of the present disclosure. In this example, the client device 202 is receiving an incoming call 204 from another user. In some examples, user of the client device 202 has an account associated with the entity placing the call. Likewise, the client device 202 may have an application pre-installed that is associated with the trusted entity.

Now referring to FIG. 2B, FIG. 2A is another example screenshot from a graphical user interface (GUI) 204 for receiving a notification regarding an incoming phone call from a user associated with a trusted entity, in accordance with some embodiments of the present disclosure. As mentioned previously, the client device 202 is receiving an incoming call 204 from another user. The client device 202 may receive a notification 206 prior to incoming call being initiated, during the incoming call, at substantially the same time as the incoming call, etc. In this example, the notification 206 may be delivered to the client devices 104 via push technology from a pre-installed application (e.g., application 106 of FIG. 1) on client device 202. In some examples, the icon of the pre-installed application on the client device 202 may provide a notification indicator (not shown), such as the number of unread notifications, in the vicinity of the icon.

As shown in notification 206, the client device 202 is provided with the verification code “534786,” which is the client-side code that was generated on client device 202. The notification 206 also includes content specifying that the incoming communication, a phone call, is associated with a particular entity, “ENTITY.” Likewise, the notification 206 instructs the user to ask the caller to recite a verification code (e.g., host-side code). In some examples, the user of the client device 202 may be prompted to confirm that the recited host-side code matches the verification code provided in the notification 206. If the host-side code matches the client-side code, the client device 202 may receive a second notification that the ongoing call is a trusted communication from the associated entity.

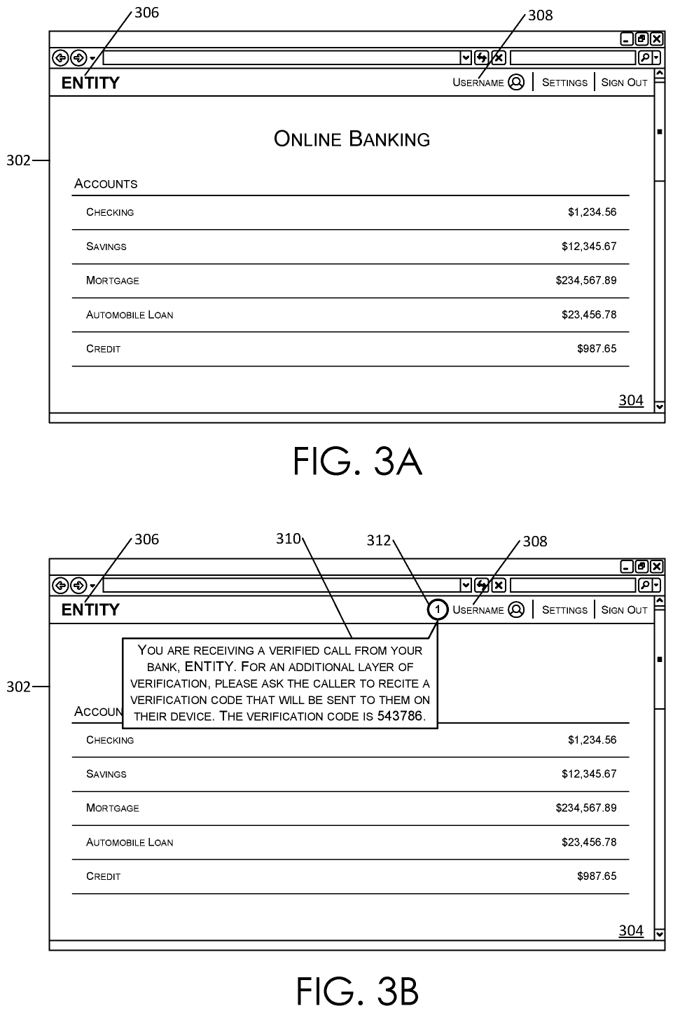

Now referring to FIG. 3A, FIG. 3A is an example screenshot from a graphical user interface (GUI) 304 for a webpage associated with a trusted entity 306, such as an online bank, in accordance with some embodiments of the present disclosure. A client device (e.g., client device 104 of FIG. 1) executing web browser 302 presents the GUI 304 for a webpage hosted by entity 306. In some embodiments, prior to navigating to the dashboard GUI 304, the user may have successfully entered credentials, as shown by the logged in username icon 308, in order to view details regarding their registered account.

Now referring to FIG. 3B, FIG. 3B is an example screenshot from a graphical user interface (GUI) 304 for a webpage associated with a trusted entity 306, such as an online bank, in accordance with some embodiments of the present disclosure. As discussed above, GUI 304 is a webpage associated with the entity 306 and rendered by web browser 302, which shows the registered user's dashboard. The user successfully entered valid credentials, as shown by the logged in username icon 308, in order to view details regarding their registered account. In this example, a client device (e.g., client device 104 of FIG. 1), such as a smartphone, is receiving a phone call initiated by a user associated with the entity. In response to the call being initiated, the registered user may receive a notification 310 and a notification indicator 312 showing that an unread notification exists.

Similar to the notification in FIG. 2B, the notification 310 in FIG. 3B provides information regarding the initiated communication: (1) the type of incoming communication (e.g., a phone call), (2) that the incoming phone call is associated with ENTITY, (3) a client-side code that matches a host-side code, and (4) an instruction to ask the caller to provide a verification code. The GUI 304 may also prompt the user to input the host-side code or provide a confirmation that the client-side and host-side codes match. The GUI 304 may additionally provide a second notification (not shown) that the additional layer of authentication was successfully completed and the ongoing call is now a trusted communication.

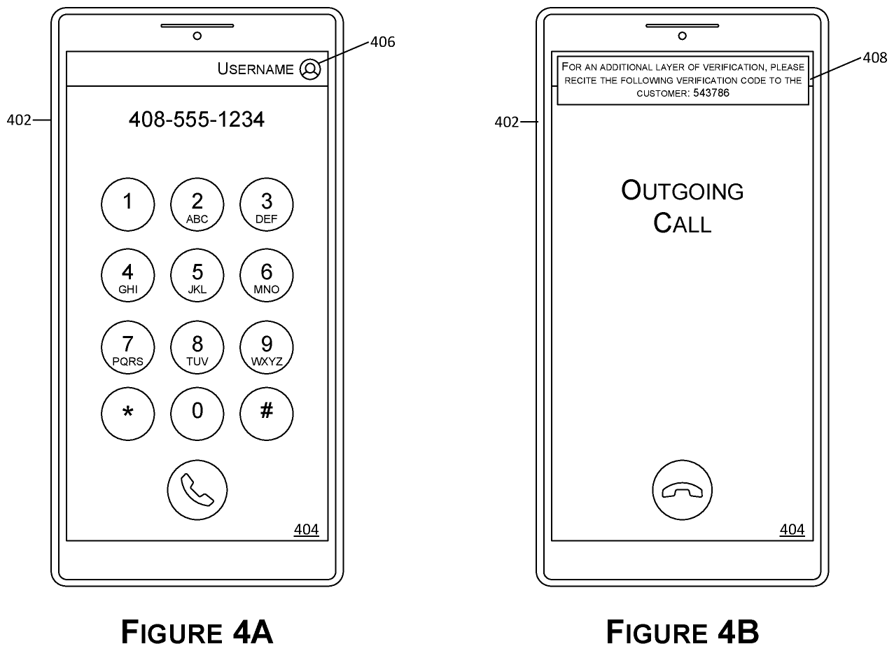

Now referring to FIG. 4A, FIG. 4A is an example screenshot from a graphical user interface (GUI) 404 for initiating a phone call from a user associated with a trusted entity to another user registered with the trusted entity, in accordance with some embodiments of the present disclosure. The GUI 404 is from an application (application 118 of FIG. 1) that is pre-installed on host device 402 and is associated with a trusted entity. As shown in GUI 404, the user of host device 402 is able to place a call through the application associated with the trusted entity. Prior to placing the call, the credentials for the user of host device 402 may have been successfully entered, as shown by the logged in user icon 406. In this example, though not shown, once the user logged in, the application may present the names and contact information of other registered users associated with the entity. The user of the host device 402 is able to select a registered user's phone number in order to initiate the phone call to that user as shown in GUI 404. In some examples, the application may also require that the user of host device 402 successfully provide valid credentials before allowing a call to be placed. Once the call has been initiated in GUI 404, an authentication signal is sent to the authentication server(s) (e.g., authentication server(s) 126 of FIG. 1), which, in turn, triggers an authentication signal to be sent to the client device receiving the phone call.

Now referring to FIG. 4B, FIG. 4B is another example screenshot from a graphical user interface (GUI) 404 for receiving a notification regarding an additional later of authentication, in accordance with some embodiments of the present disclosure. As mentioned previously, the host device 402 placed an outgoing call, as shown by GUI 404, to another user. Prior to, during, and/or at substantially the same time as the call is initiated, the host device 402 may receive a notification 408 in the form of an authentication signal from authentication server(s) (e.g., authentication server(s) 126 of FIG. 1). In this example, the notification 408 may be delivered to the host device 402 using push technology from a pre-installed application on host device 402. In some examples, the icon of the pre-installed application on client device 202 may provide a notification indicator (not shown), such as the number of unread notifications, in the vicinity of the icon.

As shown in notification 408, the host device 402 presents a notification with a verification code “534786,” which is the host-side code. This host-side code matches the client-side code provided in notification 206 in FIG. 2B and notification 310 in FIG. 3B. The host-side code may have been generated on host device 402 or received via authentication signal. As shown in notification 408, the notification 408 includes instructions for the user of host device 402 to recite the verification code to the recipient of the phone call. In some examples, the host device 402 may receive a second notification (not shown) that the ongoing call was successfully authenticated as a trusted communication from the associated entity. In some examples, the application associated with the trusted entity and pre-installed on the host device 402 may provide a notification indicator of unviewed notifications.

In some examples, the GUI 404 may display additional sensitive information regarding the recipient of the phone call. For example, with the communication authenticated as trusted, the application may allow details regarding the user's mailing address and financial account information to be displayed.

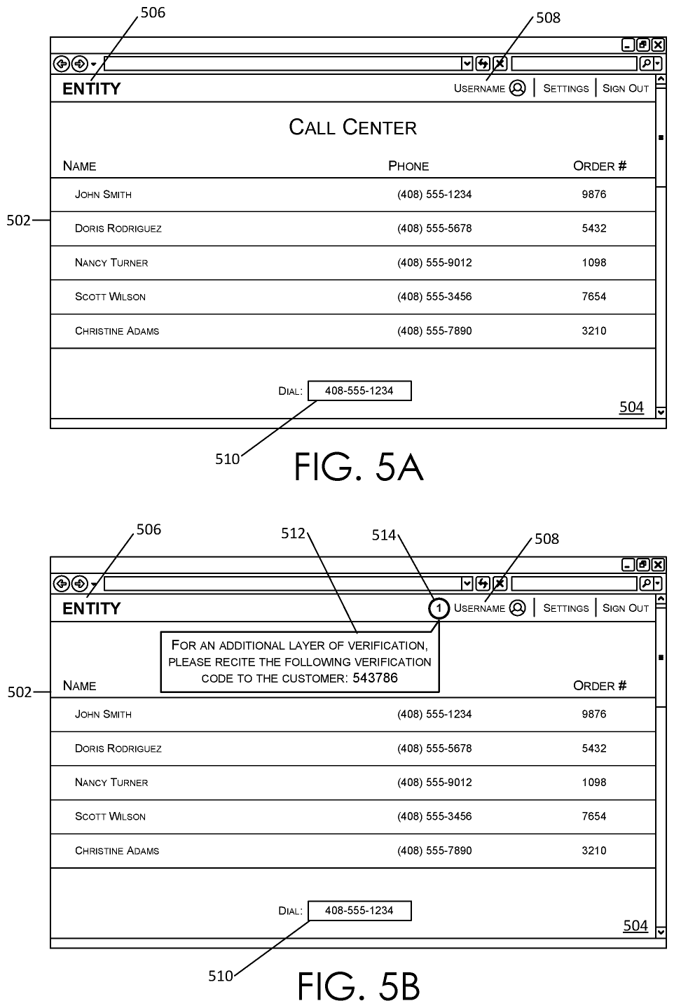

Now referring to FIG. 5A, FIG. 5A is an example screenshot from a graphical user interface (GUI) 504 for a webpage associated with a trusted entity 506, such as a call center associated with an online bank, in accordance with some embodiments of the present disclosure. A host device (e.g., host device 116 of FIG. 1) executing web browser 502 presents the GUI 504 for a webpage associated with the trusted entity 506. Prior to viewing the registered user details on GUI 504, the user of the host device may have successfully entered valid credentials, as shown by the logged in username icon 508. As the contact information of other registered users is selected, the GUI 504 provides the option to contact that registered user through an icon 510.

Now referring to FIG. 5B, FIG. 5B is an example screenshot from a graphical user interface (GUI) 504 for a notification on a webpage associated with a trusted entity 506, such as an online bank, in accordance with some embodiments of the present disclosure. As discussed above, GUI 504 is a webpage associated with the trusted entity and is rendered by web browser 502 that shows details regarding other registered users. In this screenshot, the icon 510 has been selected and a call has been placed to a client device (e.g., client device 104 of FIG. 1). To provide an added layer of authentication, the authentication server(s) (e.g., authentication server(s) 126 of FIG. 1) transmitted an authentication signal to trigger the notification 512 and caused the notification 512 and notification indicator 514 to appear.

Similar to the notification in FIG. 4B, the notification 512 in FIG. 5B provides information regarding the outgoing communication (1) a host-side code that matches a client-side code, and (2) an instruction to recite the host-side code “543786” to the caller. In some embodiments, the GUI 504 may additionally provide a second notification (not shown) that the authentication challenge was successfully completed and the outgoing call is now a verified trusted communication.

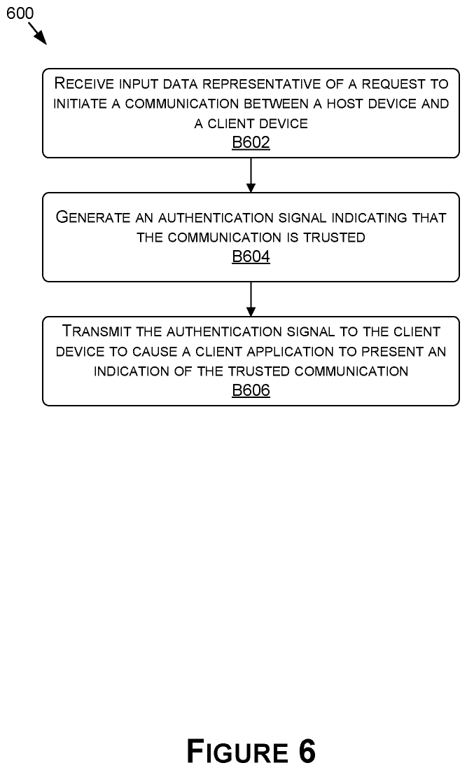

Now referring to FIGS. 6-8, each block of methods 600, 700, and 800, described herein, comprises a computing process that may be performed using any combination of hardware, firmware, and/or software. For instance, various functions may be carried out by a processor executing instructions stored in memory. The methods 600, 700, and 800 may also be embodied as computer-usable instructions stored on computer storage media. The methods 600, 700, and 800 may be provided by a standalone application, a service or hosted service (standalone or in combination with another hosted service), or a plug-in to another product, to name a few. In addition, methods 600, 700, and 800 are described, by way of example, with respect to the system 100 of FIG. 1. However, these methods 600, 700, and 800 may additionally or alternatively be executed by any one system, or any combination of systems, including, but not limited to, those described herein.

FIG. 6 is a flow diagram showing a method 600 for generating an authentication signal in response to a request to initiate a communication by a user associated with a trusted entity, in accordance with some embodiments of the present disclosure. The method 600, at block B602, includes receiving input data representative of a request to initiate a communication between a host device and a client device. For example, the authentication server(s) 126 may receive, from a host device 116, a request to initiate a communication between the host device 116 and a client device 104. The request to initiate a communication may include information such as the type of communication requested, the entity associated with the communication, and the contact information for the recipient of the communication.

The method 600, at block B604, includes generating an authentication signal indicating that the communication is trusted. In response to the request to initiate a communication, the authentication engine 128 of authentication server(s) 126 may generate an authentication signal to send to the client devices 104 that the incoming communication is associated with a trusted entity and/or that the communication is trusted. For example, the authentication signal may include the name of the entity associated with the user initiating the communication and that the communication is trusted. The authentication server(s) 126 may also verify the host-side code and client-side code against each other prior to generating the authentication signal.

The method 600, at block B606, includes transmitting the authentication signal to the client device to cause a client application to present an indication of the trusted communication. For example, authentication engine 128 of authentication server(s) 126 may transmit the authentication signal along with information such as the name of the entity associated with the user initiating the communication and that the communication is verified as trusted.

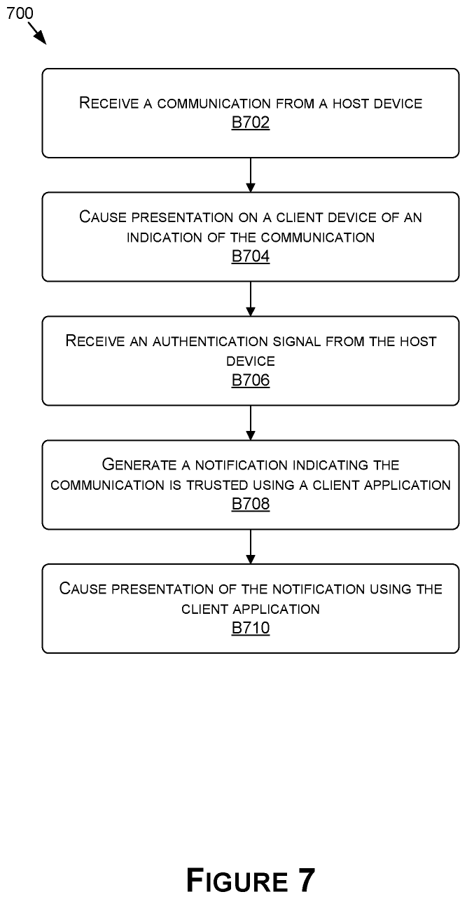

With reference to FIG. 7, FIG. 7 is a flow diagram showing a method 700 for generating and presenting a notification on a client device through an application associated with a trusted entity, in accordance with some embodiments of the present disclosure. The method 700, at block B702, includes receiving a communication from a host device. The communication may include indications as to the identity of the entity associated with the communication. For example, the communication may include caller ID or a geographic location associated with the area code that indicate the identity of the entity associated with the communication.

The method 700, at block B704, includes causing presentation on a client device of an indication of the communication. The presented indication may be information about the entity associated with the incoming communication, which may be in the form of caller ID. In some examples, a notification may be presented—e.g., in response to the request to initiate a communication—that includes the name of the entity associated with the user initiating the communication, type of communication that was initiated, and instructions regarding obtaining the host-side code.

The method 700, at block B706, includes receiving an authentication signal from the host device. For example, the authentication signal may include a host-side code that is verified against the client-side code from a client device 104. In some examples, the received host-side code may be routed to the client devices 104 for verification or verified by the authentication server(s) 126.

The method 700, at block B708, includes generating a notification indicating the communication is trusted using a client application. For example, the client devices 104 may generate a notification based on verification of the host-side code in a received authentication signal from host devices 116. In some examples, the client devices 104 may receive confirmation of the host-side code verification from the authentication server(s) 126. The notification may include information such as confirmation that the communication is trusted and that the communication is associated with a particular entity.

The method 700, at block B710, includes causing presentation of the notification using the client application. For example, the client device(s) 104 may present a notification using application 106. The notification may be presented in a variety of ways via the application 106, including audio, visual, and/or haptic forms.

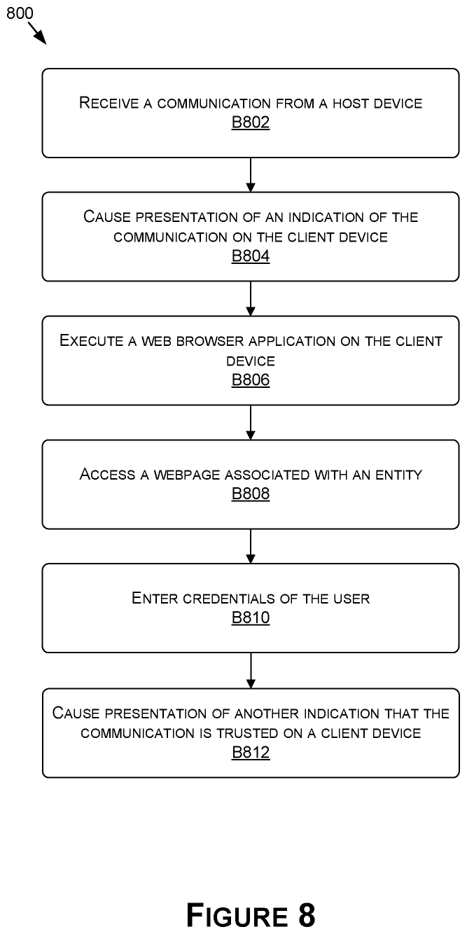

Now referring to FIG. 8, FIG. 8 is a flow diagram showing a method 800 for generating and presenting a notification on a client device through a web-based application associated with a trusted entity, in accordance with some embodiments of the present disclosure. The method 800, at block B802, includes receiving a communication from a host device. The communication may include indications, such as caller ID or a geographic location associated with the area code, as to the identity of the entity associated with the communication.

The method 800, at block B804, includes causing presentation of an indication of the communication on the client device. The indication may provide information about the call itself, such as caller ID, that describes the entity associated with a communication identifier (e.g., phone number). In some examples, in response to receiving a communication, the client devices 104 may cause presentation of an indication of the incoming communication. In some examples, the client devices 104 may present a notification that the incoming communication is associated with a trusted entity and include instructions on how to retrieve a host-side code to verify the nature of the communication.

The method 800, at block B806, includes executing a web browser application on the client device. For example, the user may access a web browser on a desktop computer in order to access a web-based application associated with the trusted entity and verify the incoming communication.

The method 800, at block B808, includes accessing a webpage associated with an entity. For example, the user may navigate to a webpage associated with the trusted entity using the web browser on client devices 104.

The method 800, at block B810, includes entering the credentials of the user. For example, the user may log into their registered account with the trusted entity via the web browser. Through the logged-in webpage associated with the entity, the user may view details regarding their account.

The method 800, at block B812, includes causing presentation of another indication that the communication is trusted. For example, after the system has authenticated the host-side and client-side codes, a notification that the ongoing communication is trusted may be presented. The notification may be generated in response to an authentication signal sent to the client devices 104 from host devices 116 through authentication server(s) 126.

Example Computing Device

FIG. 9 is a block diagram of an example computing device(s) 900 suitable for use in implementing some embodiments of the present disclosure. Computing device 900 may include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 may comprise one or more virtual machines (VMs), and/or any of the components thereof may comprise virtual components (e.g., virtual hardware components). For non-limiting examples, one or more of the GPUs 908 may comprise one or more vGPUs, one or more of the CPUs 906 may comprise one or more vCPUs, and/or one or more of the logic units 920 may comprise one or more virtual logic units. As such, a computing device(s) 900 may include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some embodiments, a presentation component 918, such as a display device, may be considered an I/O component 914 (e.g., if the display is a touch screen). As another example, the CPUs 906 and/or GPUs 908 may include memory (e.g., the memory 904 may be representative of a storage device in addition to the memory of the GPUs 908, the CPUs 906, and/or other components). In other words, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 may represent one or more links or buses, such as an address bus, a data bus, a control bus, or a combination thereof. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 may be directly connected to the memory 904. Further, the CPU 906 may be directly connected to the GPU 908. Where there is direct, or point-to-point connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an x86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU. In embodiments, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU). The GPU(s) 908 may include hundreds or thousands of cores that are capable of handling hundreds or thousands of software threads simultaneously. The GPU(s) 908 may generate pixel data for output images in response to rendering commands (e.g., rendering commands from the CPU(s) 906 received via a host interface). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using NVLINK) or may connect the GPUs through a switch (e.g., using NVSwitch). When combined together, each GPU 908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In embodiments, one or more of the logic units 920 may be a coprocessor of one or more of the CPU(s) 906 and/or one or more of the GPU(s) 908.

Examples of the logic unit(s) 920 include one or more processing cores and/or components thereof, such as Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 may include one or more receivers, transmitters, and/or transceivers that enable the computing device 900 to communicate with other computing devices via an electronic communication network, included wired and/or wireless communications. The communication interface 910 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The I/O ports 912 may enable the computing device 900 to be logically coupled to other devices including the I/O components 914, the presentation component(s) 918, and/or other components, some of which may be built in to (e.g., integrated in) the computing device 900. Illustrative I/O components 914 include a microphone, mouse, keyboard, joystick, game pad, game controller, satellite dish, scanner, printer, wireless device, etc. The I/O components 914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may be include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that enable detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to enable the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, etc.), and output the data (e.g., as an image, video, sound, etc.).

Example Data Center

FIG. 10 illustrates an example data center 1000 that may be used in at least one embodiments of the present disclosure. The data center 1000 may include a data center infrastructure layer 1010, a framework layer 1020, a software layer 1030, and/or an application layer 1040.

As shown in FIG. 10, the data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (“CPUs”) or other processors (including accelerators, field programmable gate arrays (FPGAs), graphics processors or graphics processing units (GPUs), etc.), memory devices (e.g., dynamic read-only memory), storage devices (e.g., solid state or disk drives), network input/output (“NW I/O”) devices, network switches, virtual machines (“VMs”), power modules, and/or cooling modules, etc. In some embodiments, one or more node C.R.s from among node C.R.s 1016(1)-1016(N) may correspond to a server having one or more of the above-mentioned computing resources. In addition, in some embodiments, the node C.R.s 1016(1)-10161(N) may include one or more virtual components, such as vGPUs, vCPUs, and/or the like, and/or one or more of the node C.R.s 1016(1)-1016(N) may correspond to a virtual machine (VM).

In at least one embodiment, grouped computing resources 1014 may include separate groupings of node C.R.s 1016 housed within one or more racks (not shown), or many racks housed in data centers at various geographical locations (also not shown). Separate groupings of node C.R.s 1016 within grouped computing resources 1014 may include grouped compute, network, memory or storage resources that may be configured or allocated to support one or more workloads. In at least one embodiment, several node C.R.s 1016 including CPUs, GPUs, and/or other processors may be grouped within one or more racks to provide compute resources to support one or more workloads. The one or more racks may also include any number of power modules, cooling modules, and/or network switches, in any combination.

The resource orchestrator 1022 may configure or otherwise control one or more node C.R.s 1016(1)-1016(N) and/or grouped computing resources 1014. In at least one embodiment, resource orchestrator 1022 may include a software design infrastructure (“SDI”) management entity for the data center 1000. The resource orchestrator 1022 may include hardware, software, or some combination thereof.

In at least one embodiment, as shown in FIG. 10, framework layer 1020 may include a job scheduler 1032, a configuration manager 1034, a resource manager 1036, and/or a distributed file system 1038. The framework layer 1020 may include a framework to support software 1032 of software layer 1030 and/or one or more application(s) 1042 of application layer 1040. The software 1032 or application(s) 1042 may respectively include web-based service software or applications, such as those provided by Amazon Web Services, Google Cloud and Microsoft Azure. The framework layer 1020 may be, but is not limited to, a type of free and open-source software web application framework such as Apache Spark™ (hereinafter “Spark”) that may utilize distributed file system 1038 for large-scale data processing (e.g., “big data”). In at least one embodiment, job scheduler 1032 may include a Spark driver to facilitate scheduling of workloads supported by various layers of data center 1000. The configuration manager 1034 may be capable of configuring different layers such as software layer 1030 and framework layer 1020 including Spark and distributed file system 1038 for supporting large-scale data processing. The resource manager 1036 may be capable of managing clustered or grouped computing resources mapped to or allocated for support of distributed file system 1038 and job scheduler 1032. In at least one embodiment, clustered or grouped computing resources may include grouped computing resource 1014 at data center infrastructure layer 1010. The resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. Self-modifying actions may relieve a data center operator of data center 1000 from making possibly bad configuration decisions and possibly avoiding underutilized and/or poor performing portions of a data center.

The data center 1000 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1000. In at least one embodiment, trained or deployed machine learning models corresponding to one or more neural networks may be used to infer or predict information using resources described above with respect to the data center 1000 by using weight parameters calculated through one or more training techniques, such as but not limited to those described herein.

In at least one embodiment, the data center 1000 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 900 of FIG. 9—e.g., each device may include similar components, features, and/or functionality of the computing device(s) 900. In addition, where backend devices (e.g., servers, NAS, etc.) are implemented, the backend devices may be included as part of a data center 1000, an example of which is described in more detail herein with respect to FIG. 10.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 900 described herein with respect to FIG. 9. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-usable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

1. A method comprising:
receiving input data representative of a request to initiate a communication between a host device of an entity and a client device of a user;
responsive to the request, generating an authentication signal indicating that the communication is a trusted communication;
transmitting the authentication signal to the client device to cause a client application associated with the entity to generate and present, on the client device, an indication of the trusted communication; and
initiating the communication between the host device and the client device.

2. The method of claim 1, further comprising, based at least in part on the request, generating and presenting a host-side code within a host application, the host-side code for verifying against a client-side code associated with the indication of the trusted communication.

3. The method of claim 2, further comprising receiving, from the client device, a verification that the host-side code matched the client-side code.

4. The method of claim 1, wherein the communication is at least one of a phone call over a public switched telephone network (PSTN) or a cellular network, a voice over internet protocol (VoIP) call, a text message, an instant message, or a short message service (SMS) message.

5. The method of claim 1, wherein the indication corresponds to at least one of a notification, a push notification, or a notification indicator.

6. The method of claim 1, wherein the authentication signal causes the client application to generate the indication responsive to a verification process, the verification process including one or more of verifying a time-sensitive value or verifying a password.

7. The method of claim 1, further comprising:
verifying, within a host application associated with the entity, that another user of the host application is authorized to generate the request,
wherein the receiving the input data representative of the request is based at least in part on the verifying.

8. The method of claim 1, further comprising:
responsive to the request, updating a user account of the user for a webpage associated with the entity, the updating including providing another indication within the user account that the communication is the trusted communication.

9. A method comprising:
receiving, from a host device, a request for a communication;
based at least in part on the requested communication, causing presentation, on a client device, of an indication of the requested communication;
receiving, from the host device, an authentication signal generated by the host device based at least in part on the requested communication;
based at least in part on the receiving the authentication signal, generating, using a client application of the client device, a notification indicating that the requested communication is a trusted communication;
causing presentation, using the client application and on the client device, of the notification; and
accepting the requested communication from the host device based at least in part on the notification.

10. The method of claim 9, further comprising:
verifying received verification data represented by the authentication signal against known verification data stored on the client device,
wherein the generating the notification is responsive to the verifying.

11. The method of claim 10, wherein the received verification data and the known verification data correspond to one or more of a time-sensitive value or a password.

12. The method of claim 10, wherein the known verification data stored on the client device is stored as a cookie.

13. The method of claim 9, wherein the communication is at least one of a phone call over a public switched telephone network (PSTN) or a cellular network, a voice over internet protocol (VoIP) call, a text message, an instant message, or a short message service (SMS) message.

14. The method of claim 9, wherein the notification is presented in at least one of a audio, visual, or haptic delivery methods.

15. The method of claim 11, wherein the password is at least one of a PIN number, secret word, answer to a security question, or identification number.

16. A system comprising:
one or more processors; and
one or more memory devices that store instructions that, when executed by the one or more processors, cause the one or more processors to execute operations comprising:
receiving, from a host device, a communication;
based at least in part on the communication, causing presentation, on a client device, of a first indication of the communication;
executing a web browser application on the client device;
accessing, using the web browser, a webpage associated with an entity that initiated the communication;
entering, to the webpage, credentials of a user;
based at least in part on verification of the credentials, causing presentation, on the client device, of a second indication that the communication is a trusted communication.

17. The system of claim 16, wherein the first indication further indicates an entity associated with the communication.

18. The system of claim 16, wherein the operations further comprise:
receiving input data representative of a verification code used to authenticate the host device; and
based at least in part on the verification code being valid, transmitting, to the host device, data indicating that the host device is authenticated.

19. The system of claim 18, wherein the data indicating that the host device is authenticated allows the host device to access additional information of the user.

20. The system of claim 16, wherein the operations further comprise, based at least in part on verification of the credentials, causing presentation, on the client device, of a notification indicator.
